(19) United States
(12) Patent Application Publication
(10) Pub. No.: US 2025/0247125 A1
(43) Pub. Date: Jul. 31, 2025

(54) TRANSCEIVER FRONT-END INCLUDING RECEIVER BRANCH VARIABLE INDUCTOR AND/OR TRANSMITTER BRANCH VARIABLE CAPACITOR

(71) Applicant: GlobalFoundries U.S. Inc., Malta, NY (US)

(72) Inventors: Abdellatif Bellaouar, Richardson, TX (US); Arul Balasubramaniyan, Plano, TX (US); Shafiullah Syed, Murphy, TX (US)

(21) Appl. No.: 18/427,648

(22) Filed: Jan. 30, 2024

(51) Int. Cl. H04B 1/525; H04B 1/04

(52) U.S. Cl. CPC H04B 1/525; H04B 1/04; H04B 2001/0408

(57) ABSTRACT

A transceiver front-end (FE) includes a receiver from an I/O pad to an amplifier (e.g., a low noise amplifier (LNA)) and a transmitter from the I/O pad to another amplifier (e.g., a power amplifier (PA)). The receiver further includes a variable inductor connected at one end to the I/O pad and connectable at the opposite end to ground by a switch. The LNA is connected to a node between portions of the inductor. When receiving, the switch is opened so the inductor exhibits low inductance for LNA impedance matching. When transmitting, the switch is closed so the inductor exhibits high inductance for blocking leakage to the LNA. Additionally, or alternatively, the transmitter includes a variable capacitor connected to the I/O pad. When receiving, the capacitor is programmed to exhibit low capacitance for optimal LNA performance. When transmitting, the capacitor is programmed to exhibit high capacitance for optimal PA performance.

### BACKGROUND

The present disclosure relates to transceiver front-ends (FEs) and, more particularly, to embodiments of a transceiver FE configured for time division duplexing (TDD) operation.

A transceiver is a device that includes both a receiver and a transmitter, which share a common antenna or a common antenna array. A transceiver FE refers to circuitry within the transceiver including an input/output (I/O) pad connected to the antenna, a receiver branch from the I/O pad to and including a low noise amplifier (LNA), and a transmitter branch from the I/O pad to and including a power amplifier (PA). Some transceiver FE architectures are configured for TDD operation. In TDD operation, a switch in the receiver branch and, optionally, another switch in the transmitter branch selectively connect either the LNA of the receiver branch to the I/O pad to receive signals or the PA of the transmitter branch to the I/O pad for transmitting signals. However, complex circuitry is often incorporated into the receiver branch and/or the transmitter branch to minimize signal loss. For example, within the receiver branch, multiple stacked transistors may be incorporated into the switch to support a large voltage switch at the antenna and a complex matching network (MN) may incorporated between the I/O pad and the LNA for impedance matching.

### SUMMARY

Disclosed herein are embodiments of a transceiver FE. In some embodiments, the transceiver FE can include an I/O pad and a receiver branch, which is connected to the I/O pad. The receiver branch can include a mode control switch. The receiver branch can further include a variable inductor, which has end nodes connected to the I/O pad and the mode control switch, respectively. The variable inductor can further be connectable to ground through the mode control switch. The receiver branch can further include a receiver branch amplifier, which is connected to an intermediate node between a first portion and a second portion of the variable inductor.

In other embodiments, the transceiver FE can include an I/O pad and a transmitter branch, which is connected to the input/output pad. The transmitter branch can include an output node, which is connected to the I/O pad. The transmitter branch can further include a transmitter branch amplifier and a transformer, which is connected between the transmitter branch amplifier and the output node. The transmitter branch can further include a variable capacitor connected to the output node.

In still other embodiment, the transceiver FET can include an I/O pad, a receiver branch, and a transmitter branch.

The receiver branch can be connected to the I/O pad. The receiver branch can further include a mode control switch and a variable inductor. The variable inductor can have end nodes, which are connected to the I/O pad and the mode control switch, respectively. The variable conductor can further be connectable to ground through the mode control switch. The receiver branch can further include a receiver branch amplifier, which is connected to an intermediate node between a first portion and a second portion of the variable inductor.

The transmitter branch can also be connected to the I/O pad. The transmitter branch can include an output node, which is connected to the input/output pad. The transmitter branch can further include a transmitter branch amplifier and a transformer, which is connected between the transmitter branch amplifier and the output node. The transmitter branch can also include a variable capacitor connected to the output node.

It should be noted that all aspects, examples, and features of disclosed embodiments mentioned in the summary above can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1 is a schematic diagram illustrating embodiments of a transceiver FE;

FIG. 2 is a layout diagram illustrating an example of an inductor that could be incorporated into a receiver branch of the transceiver FE of FIG. 1;

FIG. 3 is a schematic diagram illustrating an example of a mode control switch that could be incorporated into a receiver branch of the transceiver FE of FIG. 1;

FIG. 4 is a schematic diagram illustrating an example of a variable capacitor that could be incorporated into a transmitter branch of the transceiver FE of FIG.; 1;

FIG. 5 is a schematic diagram illustrating an example of a matching network that could be incorporated into transceiver FE of FIG. 1; and

FIG. 6 is a schematic diagram illustrating an example of a prior art transceiver FE.

### DETAILED DESCRIPTION

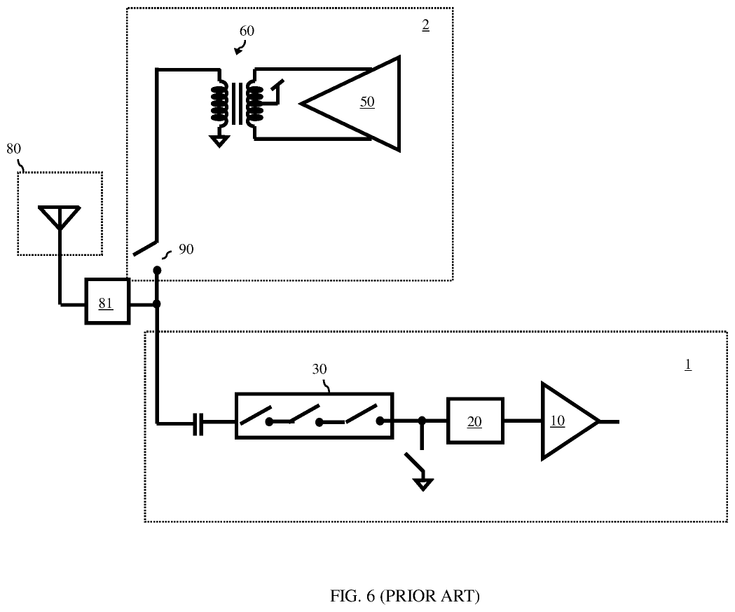

FIG. 6 is a schematic diagram illustrating a typical transceiver FE configured for TDD operation. The transceiver FE includes I/O pad 81 connected to an antenna 80, a receiver branch 1 from I/O pad 81 to and including a LNA 10 and a transmitter branch 2 from I/O pad 81 to and including PA 50. The transceiver FE further includes a switch 30 in receiver branch 1 and, optionally, another switch 90 in transmitter branch 2. Such switch(es) 30, 90 are used to selectively connect either LNA 10 or PA 50 to I/O pad 81. Transmitter branch 2 further includes an impedance transformer 60 for providing impedance matching between an output signal from PA 50 and an input to antenna 80. Receiver branch 1 further includes: multiple stacked transistors in switch 30 to support a large voltage switch at antenna 80; and a complex MN 20 between I/O pad 81 and LNA 10 for impedance matching.

In view of the foregoing, disclosed here are embodiments of a transceiver FE configured for TDD operation. In the disclosed embodiments, the transceiver FE can include an I/O pad connected to an antenna (e.g., a single antenna or an antenna array), a receiver branch from the I/O pad to and including a receiver branch amplifier (e.g., an LNA), and a transmitter branch from the I/O pad to and including a transmitter branch amplifier (e.g., a PA). The receiver branch can further include a variable inductor, which is connected at one end to the I/O pad and which is selectively connectable at the opposite end to ground by a mode control switch. The LNA can be connected to the variable inductor at an intermediate node between first and second portions of the variable inductor. When receiving, the mode control switch can be opened (i.e., non-conductive) so the variable inductor exhibits relatively low inductance for impedance matching with the LNA. When transmitting, the mode control switch can be closed (i.e., conductive) so the variable inductor exhibits relatively high inductance for blocking current leakage from the transmitter branch to the LNA. Additionally, or alternatively, the transmitter branch can include a variable capacitor (e.g., a digitally controlled capacitor), which is connected to a transmitter branch output node and thereby to the I/O pad. When receiving, the variable capacitor can be programmed to exhibit relatively low capacitance for optimal LNA performance. When transmitting, the variable capacitor can be programmed to exhibit relatively high capacitance for optimal PA performance (e.g., high gain). As discussed in greater detail below, in the disclosed transceiver FE, the noise factor (NF) of the LNA in the receiver branch can be reduced significantly as compared to the NF of an LNA in a standalone receiver. Furthermore, the impact on the performance of the LNA in the receiver branch as compared to the performance of an LNA standalone receiver may be minimal. Similarly, the impact on the performance of the PA in the transmitter branch as compared to the performance of a PA in a standalone transmitter may also be minimal.

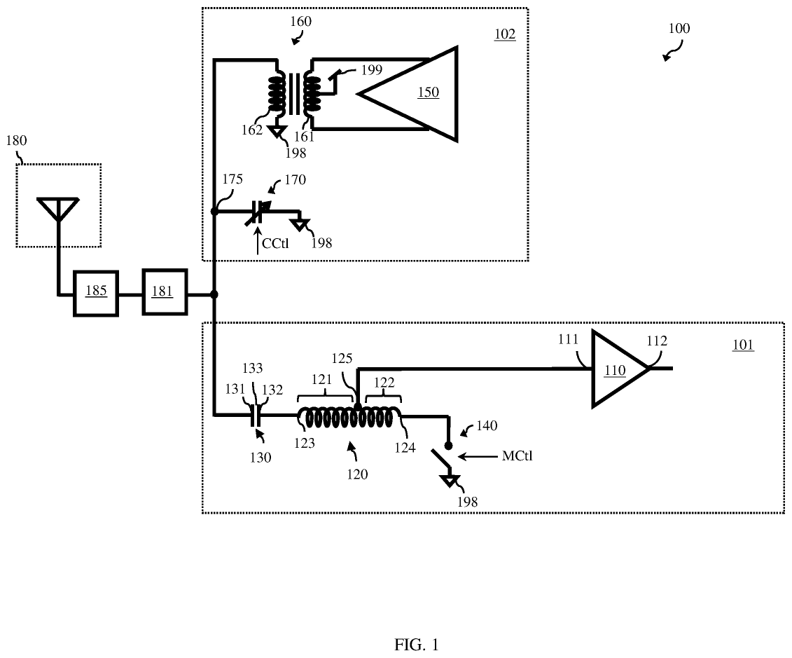

FIG. 1 is a schematic diagram illustrating a disclosed embodiment of a transceiver FE 100. Transceiver FE 100 can include: an antenna 180; an input/output (I/O) pad 181; a matching network (MN) 185 electrically connected between I/O pad 181 and antenna 180; a receiver branch 101 electrically connected to I/O pad 181 and thereby to antenna 180; and a transmitter branch 102 also electrically connected to I/O pad 181 and thereby to antenna 180.

Antenna 180 can be a single antenna. Alternatively, antenna 180 can be an antenna array. Such antennas are well known in the art and, thus, the details thereof have been omitted from this specification in order to allow the reader to focus on the salient aspects of the disclosed embodiments. As mentioned above, a transceiver is a device that includes both a receiver and a transmitter, which share a common antenna or a common antenna array.

As mentioned above, receiver branch 101 can be electrically connected to I/O pad 181 and thereby to antenna 180. Receiver branch 101 can process (i.e., can be adapted to process, can be configured to process, etc.) an input signal (e.g., a radio frequency (RF) signal) received by antenna 180 during a receiving mode.

Specifically, receiver branch 101 can include a receiver branch amplifier 110. Receiver branch amplifier 110 can be, for example, a low noise amplifier (LNA). An LNA is an electronic component that can amplify (i.e., that is adapted to amplify or boost, that is configured to amplify or boost, etc.) a received signal without significantly degrading its signal-to-noise ratio (SNR) so that it can be processed by components (e.g., mixer, bandpass filter, etc.) downstream of the LNA in the receiver. Those skilled in the art will recognize that the LNA is generally employed within the transceiver FE to maximize receiver sensitivity. Various different LNA configurations are well known in the art and could be incorporated into receiver branch 101. In any case, receiver branch amplifier 110 can have an input 111 and an output 112.

Receiver branch 101 can further include an inductor 120, a receiver branch capacitor 130, and a mode control switch 140.

An inductor refers to a passive electronic component, which includes a wire in a coil or spiral shape and wrapped by an insulator and which stores energy in a magnetic field when electric current flows therethrough. Inductance refers to the tendency of the inductor to oppose a change in the electric current flowing through it. Inductor 120 can include a first end node 123 at one end of wire (e.g., in a coil or spiral shape and wrapped by an insulator), a second end node 124 at an opposite end of the wire, and an intermediate node 125 on the wire between the two end nodes 123 and 124. Thus, a first portion 121 of inductor 120 extends from first end node 123 to intermediate node 125 and a second portion 122 of inductor 120 extends from intermediate node 125 to second end node 124. Intermediate node 125 can be electrically connected to input node 111 of receiver branch amplifier 110.

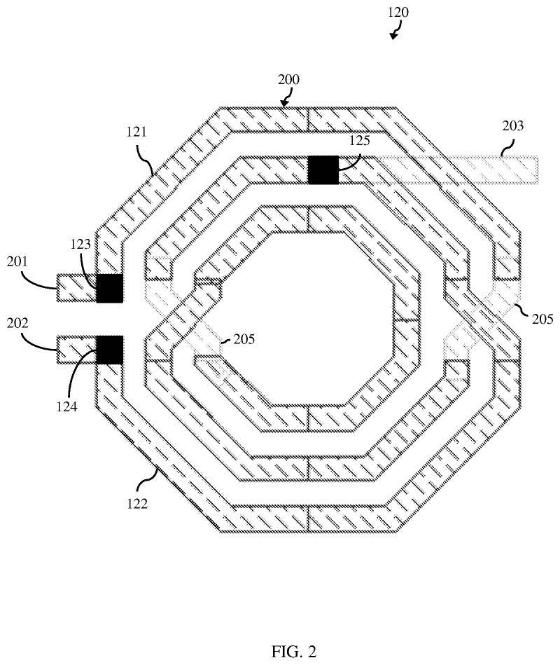

FIG. 2 is a layout diagram illustrating an example of an inductor 120 and, particularly, a spiral inductor that could be incorporated into receiver branch 101. This inductor 120 can include a wire 200 of a metal or metal alloy material (e.g., copper or some other BEOL metal or metal alloy material). Wire 200 can be patterned into an essentially planar spiral shape that, for the most part, is contained within a single back end of the line (BEOL) metal level of a chip. Wire 200 can include opposite ends 201 and 202. As illustrated, opposite ends 201 and 202 can both be on the outside of the spiral shape (as opposed to one end being within the center of the spiral shape and one end being outside the spiral shape). In this case, at least some of the spiral segments within wire 200 cross, as illustrated, without contacting each other using interconnects 205 (including combinations of vias and a wire segment in a metal level above or below) to achieve a continuous spiral shape. Inductor 120 can include a first end node 123 at end 201 of the wire 200 and a second end node 124 at end 202 of the wire 200. Inductor 120 can also include intermediate node 125 on the wire 200 between end nodes 123 and 124. Thus, a first portion 121 of inductor 120 extends from first end node 123 to intermediate node 125 and a second portion 122 of inductor 120 extends from intermediate node 125 to second end node 124. Intermediate node 125 can be electrically connected to input node 111 of receiver branch amplifier 110 by an additional interconnect 203 (e.g., including a combination of BEOL via(s) and wire segment(s)). It should be understood that the example inductor shown in FIG. 2 is provided for illustration purposes and is not intended to be limiting. Various different inductor configurations are known in the art (e.g., spiral inductors, coil inductors, etc.) and could, alternatively, be incorporated into receiver branch 101 as inductor 120.

Capacitor 130 can include a pair of conductive plates and, particularly, a first conductive plate 131 (also referred to herein as a first capacitor plate) electrically connected to I/O pad 181 and a second conductive plate 132 (also referred to herein as a second capacitor plate) electrically connected to first end node 123 of inductor 120. The capacitor 130 can further include a capacitor dielectric 133 between first and second conductive plates 131 and 132. Capacitor 130 can be an alternating current (AC) coupling capacitor.

Mode control switch 140 can have terminals electrically connected to second end node 124 of inductor 120 and to ground, respectively. Additionally, open and closed states of mode control switch 140 can be controlled by at least one mode control signal (MCtl) to allow inductor 120 to be selectively disconnected from ground 198 or electrically connected to ground 198. If mode control switch 140 is open (i.e., second end node 124 of inductor 120 is not electrically connected to ground 198) current will pass through first portion 121 of inductor 120 between first end node 123 and intermediate node 125 (and to receiver branch amplifier 110), but not through second portion 122 of inductor 120 between intermediate node 125 and ground. If mode control switch 140 is closed (i.e., second end node 124 of inductor 120 is electrically connected to ground 198) current will pass through both first portion 121 of inductor 120 between first end node 123 and intermediate node 125 and through second portion 122 of inductor 120 between intermediate node 125 and ground. Thus, when mode control switch 140 is open, inductance of inductor 120 will be at a first inductance value based current flow through first portion 121 only. However, when mode control switch 140 is closed, inductance of inductor 120 will be at a second inductance value that is greater than the first inductance value based on current flow through the entire inductor (i.e., first portion 121 and second portion 122). Thus, by incorporating mode control switch 140 into receiver branch 101 and connecting receiver branch amplifier 110 to intermediate node 125 (as opposed to second end node 124), inductor 120 effectively functions as a variable inductor.

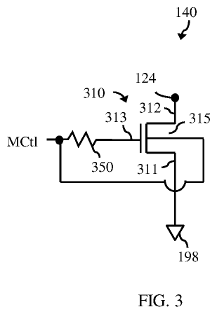

FIG. 3 is a schematic diagram illustrating an example of a mode control switch 140 that could be incorporated into receiver branch 101. This mode control switch 140 can be an N-channel field effect transistor (NFET) 310. The NFET 310 can have a source region 311 connected to ground 198, a drain region 312 connected to second end node 124 of inductor 120, and a channel region positioned laterally between source region 311 and drain region 312. The NFET 310 can further include a gate 313 adjacent to the channel region and electrically connected (e.g., via a floating resistor 350) to receive MCtl. The floating resistor helps to reduce capacitance of the switch and further improves reliability by floating the gate of the switch. In the case of an NFET 310, when MCtl is at a low voltage level (e.g., at zero volts or a negative voltage level), the NFET 310 will be open (i.e., non-conductive) such that inductor 120 will be disconnected from ground 198. When MCtl is at a high voltage level (e.g., at a positive voltage level), the NFET 310 will be closed (i.e., conductive) such that inductor 120 will be disconnected from ground 198. Optionally, the NFET 310 can include an additional biasable region 315 connected to receive MCtl. The additional biasable region 315 can be either a body region also connected to receive MCtl (e.g., in the case of a partially depleted NFET) or a back gate also connected to receive MCtl (e.g., in the case of a fully depleted semiconductor-on-insulator, such as a fully depleted silicon-on-insulator (FDSOI) NFET). By connecting the body region (or back gate) to receive MCtl, the threshold voltage (VT) of the NFET is reduced when MCtl is high and leakage current is reduced when MCtl is low. It should be understood that the example mode control switch shown in FIG. 3 is provided for illustration purposes and is not intended to be limiting. Various different switch configurations are known in the art (e.g., stacked NFETs, transmission gates, etc.) and could, alternatively, be incorporated into receiver branch 101 as mode control switch 140.

As mentioned above, transmitter branch 102 can also be connected to I/O pad 181. Transmitter branch 102 can generate (i.e., can be adapted to generate, can be configured to generate, etc.) an output signal (e.g., an RF signal), passing it to antenna 180 for subsequent transmission, during a transmitting mode.

Transmitter branch 102 can include a transmitter branch amplifier 150 and an impedance transformer 160, which couples transmitter branch amplifier 150 to an output node 175 and, thereby to I/O pad 181.

Transmitter branch amplifier 150 can be, for example, a power amplifier (PA). A PA is an electronic component that can generate (i.e., that is adapted to generate, that is configured to generate, etc.) high power radio frequency (RF) output signals from low power RF output signals. In illustrative embodiments, the high power RF output signals generated by transmitter branch amplifier 150 can be millimeter wave (mmWave) RF output signals (i.e., between 24 GHz and 100 GHz, such as at 28 GHz) for 5G applications. Alternatively, the high power RF output signals generated by transmitter branch amplifier 150 can be RF signals in any other part of the RF spectrum. In an example embodiment, transmitter branch amplifier 150 can have an output voltage swing with a peak between 2.0 and 5 volts (e.g., at 2.5V, at 3V, at 3.5V, at 4V, etc.). Various different PA configurations are well known in the art and could be incorporated into transmitter branch 102.

Impedance transformer 160 can include, for example, a pair of back-to-back inductors. The back-to-back inductors can include a primary winding 161, which is connected to receive a positive supply voltage 199 and further connected to receive an output signal (e.g., a differential output signal) from the transmitter branch amplifier 150. The back-to-back inductors can also include a secondary winding 162 with opposite ends connected to ground 198 and to output node 175. Due to inductive coupling, a corresponding output signal can appear on the secondary winding 162 and can pass to output node 175 and, thereby to I/O pad 181 for subsequent transmission by the antenna 180. Depending upon the turns ratio between the two windings, the impedance transformer 160 provides impedance matching necessary between the output signal from the transmitter branch amplifier 150 and the input to the antenna 180.

Transmitter branch 102 can also include a variable capacitor 170, which is electrically connected to output node 175. Variable capacitor 170 can be programmable to allow at least two different capacitance values (e.g., a first capacitance value and a second capacitance value that is greater than the first capacitance value) to be exhibited at output node 175 (e.g., depending upon the operating mode).

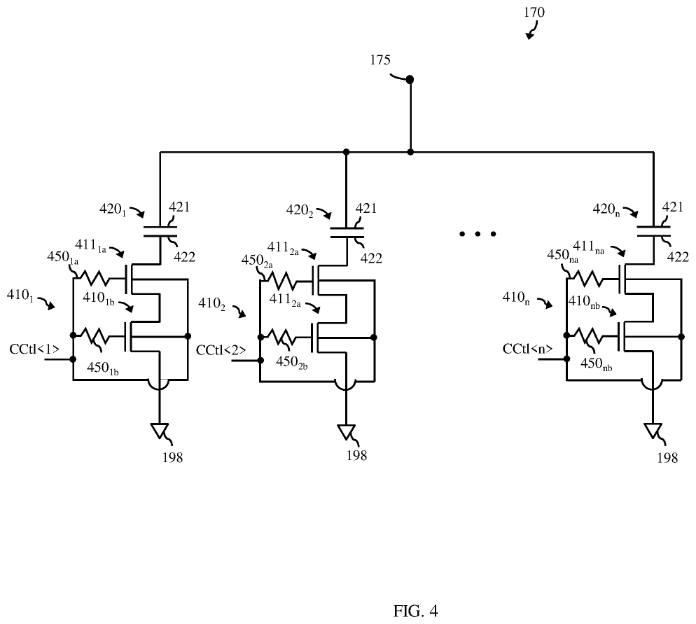

FIG. 4 is a schematic diagram illustrating an example of a variable capacitor 170 that could be incorporated into transmitter branch 102. The variable capacitor 170 shown in FIG. 4 is a digitally controlled capacitor. This digitally controlled capacitor can include multiple capacitors 420₁-420ₙ electrically connected to output node 175 and further connectable by multiple capacitance control switches 410₁-410ₙ, respectively, to ground. Specifically, each capacitor 420₁-420ₙ can include a first conductive plate 421 (also referred to herein as a first capacitor plate) electrically connected to output node 175, a second conductive plate 422 (also referred to herein as a second capacitor plate) electrically connected to a corresponding capacitance control switch 410₁-410ₙ, and a capacitor dielectric layer between the first and second conductive plates 421-422. Each capacitance control switch 410₁-410ₙ can include at least one NFET. Optionally, as illustrated, each capacitance control switch 410₁-410ₙ can include a pair of stacked NFETs connected between a capacitor and ground. For example, capacitance control switch 410₁ can include a pair of NFETs 411₁ₐ-411_{1b} connected in series between first conductive plate 421 of capacitor 420₁ and ground 198; capacitance control switch 410₂ can include a pair of NFETs 411₂ₐ-410_{2b} connected in series between first conductive plate 421 of capacitor 420₂ and ground 198; and so on. CCtl can be a multi-bit digital signal with each bit being received by a corresponding capacitance control switch. Thus, for example, NFETs 411₁ₐ-411_{1b} can have gates connected via floating resistors 450₁ₐ-450_{1b} to receive a first bit (CCtl<1>) of CCtl; NFETs 411₂ₐ-411_{2b} can have gates connected via floating resistors 450₂ₐ-450_{2b} to receive a second bit (CCtl<2>) of CCtl; and so on. The floating resistors help to reduce capacitance of the switches and further improve reliability by floating the gates of the switches.

In the example digitally controlled capacitor of FIG. 4, if the CCtl bit received by a capacitance control switch is at a low voltage level (e.g., at a logic 0), the NFETs therein will be non-conductive and only the parasitic capacitor will be connected to the capacitor 420₁-420ₙ. So, the total capacitance of the capacitor connected to the switch will be low. However, if the CCtl bit received by a capacitance control switch is at a high voltage level (e.g., at a logic 1), the NFETs therein will be conductive so capacitance of the capacitor connected to the switch will be connected to the ground 198 and hence resulting in a high value. Thus, in in this digitally controlled capacitor, overall capacitance will be at the lowest level when all capacitance control switches 410₁-410ₙ are open so none of capacitors 420₁-420ₙ are connected to ground 198. Furthermore, overall capacitance will be at the highest level when all capacitance control switches 410₁-410ₙ are closed so all of capacitors 420₁-420ₙ are connected to ground 198.

It should be understood that example digitally controlled capacitor shown in FIG. 4 is provided for illustration purposes and is not intended to be limiting. For example, FIG. 4 shows a digitally controlled capacitor with three capacitors connected by three capacitance control switches, respectively, between the output node and ground. Alternatively, the digitally controlled capacitor could include any number of two or more capacitors connected by capacitance control switches, respectively, between the output node and ground. Furthermore, various different variable capacitor configurations, including different digitally controlled capacitance configurations, are known in the art and could, alternatively, be incorporated into transmitter branch 102 as variable capacitor 170.

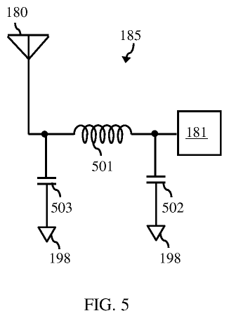

Transceiver FE 100 can further include a matching network (MN) 185 between I/O pad 181 and antenna 180. MN 185 can provide (i.e., can be adapted to provide, configured to provide, etc.) impedance matching between the transmitter branch amplifier 150 (e.g., a PA) and antenna 180 during the transmitting mode in conjunction with both the capacitance of capacitor 130 and the inductance of inductor 120 in the receiver branch 101. FIG. 5 is a schematic diagram illustrating an example of a MN 185 that can be incorporated into transceiver FE 100 between I/O pad 181 and antenna 180. MN 185 can include, for example, an inductor 501 having opposing ends connected to I/O pad 181 and antenna 180. MN 185 can further include, for example, a pair of capacitors 502 and 503. Capacitor 502 can be electrically connected between one end of inductor 501 and ground 198. Capacitor 503 can be electrically connected between the opposite end of inductor 501 and ground 198. It should be understood that the example matching network shown in FIG. 5 is provided for illustration purposes and is not intended to be limiting. Various different matching network configurations are known in the art (including different combinations of inductor(s), capacitor(s), and resistor(s)) and could, alternatively, be designed and incorporated into transceiver FE 100 to provide impedance matching with antenna 180. It should be noted that such a MN 185 would only provide impedance transformation during the receiving mode.

In any case, in some embodiments, all components of transceiver FE 100 can be on a single integrated circuit (IC) chip. In other embodiments, some components of transceiver FE 100 can be on-chip and others can be off-chip. For example, an embodiment of transceiver FE 100 can include an on-chip section and an off-chip section. The on-chip section can include I/O pad 181, receiver branch 101 and transmitter branch 102 all on the same IC chip. The off-chip section can include antenna 180 and MN 185, which are external to the IC chip (e.g., on a printed circuit board (PCB)).

As mentioned above, this transceiver FE 100 is configured for TDD operation. That is, it can operate in either a receiving mode or a transmitting mode. During the receiving mode, input signals received by antenna 180 pass to I/O pad 181 and through receiver branch 101 where they are processed by receiver branch amplifier 110 (e.g., an LNA). During the transmitting mode, output signals are generated by transmitter branch amplifier 150 in transmitter branch 102, passed by impedance transformer 160 to output node 175 and on to I/O pad 181 for subsequent transmission via antenna 180.

In the different modes of operation, MCtl and CCtl can be switched, as discussed below, to achieve optimal performance.

For example, during the receiving mode, inductance of inductor 120 in receiver branch 101 should be relatively low (e.g., at the first inductance value) so that electric current can flow therethrough to receiver branch amplifier 110. As mentioned above, inductance of inductor 120 will be at the first inductance value when MCtl causes mode control switch 140 to open, disconnecting end node 124 of inductor 120 from ground. The amount of inductance can be established based on the size of first portion 121 of inductor 120 to provide impedance matching for receiver branch amplifier 110. Furthermore, during the receiving mode, capacitance of variable capacitor 170 in the transmitter branch 102 should be relatively low (e.g., at a first capacitance value), such as at zero capacitance, in order to minimize both the input reflection coefficient (S11) and the NF of the receiver branch amplifier 110 (e.g., the LNA). As mentioned above, capacitance of variable capacitor 170 and, particularly, a digitally controlled capacitor will be at the lowest level when all capacitance control switches 410₁-410ₙ are open so none of capacitors 420₁-420ₙ are connected to ground 198. It should be noted that in the receiving mode the capacitance provided by capacitor 130 is employed to isolate antenna 180, when at 0.0 volts (e.g., at ground) from LNA bias.

However, during the transmitting mode, inductance of inductor 120 in receiver branch 101 should be relatively high (e.g., at the second inductance value that is higher than the first inductance value) so that electric current is blocked from flowing therethrough to receiver branch amplifier 110. Thus, this relatively high inductance prevents leakage from transmitter branch 102 to receiver branch amplifier 110 (e.g., to the LNA). As mentioned above, inductance of inductor 120 will be at the second inductance value when mode control switch 140 is closed (i.e., when inductor 120 is electrically connected to ground by mode control switch 140). The amount of inductance will be based on the overall size of inductor 120 (including first portion 121 and second portion 122). Furthermore, during the transmitting mode, capacitance of variable capacitor 170 in the transmitter branch 102 should be relatively high (e.g., at a second capacitance value that is greater than the first capacitance value) in order to achieve optimal performance (e.g., optimal gain and Pout) in the transmitter branch amplifier 150 (e.g., the PA). As mentioned above, capacitance of variable capacitor 170 and, particularly, a digitally controlled capacitor will be at the highest level when all capacitance control switches 410₁-410ₙ are closed so that all capacitors 420₁-420ₙ are connected to ground 198. By providing a means for selectively adjusting overall capacitance of variable capacitor 170, impedance matching with antenna 180 can be finely tuned. That is, impedance matching between transmitter branch amplifier 150 (e.g., the PA) and antenna 180 during the transmitting mode is generally provided by a global matching network (GMN) that includes MN 185 and, within the receiver branch 101, capacitor 130 and inductor 120. This GMN can be designed to match an ideal antenna impedance (e.g., of 50 Ohms). However, those skilled in the art will recognize that practically the antenna impedance might be different from the ideal antenna impedance. By selectively adjusting capacitance of the digitally controlled capacitor, improved impedance matching with antenna 180 can be partially achieved. Additionally, it should be noted that mode control switch 140 should have a relatively low on resistance (Ron) (e.g., of approximately 3 Ohms at 27 GHz) so that, when switching from the receiving mode to the transmitting mode, transmitter branch amplifier 150 (e.g., the PA) sees a high input equivalent resistance (>>than Ropt provided by the matching network. Example Ropt ˜20 Ohms @ 28 GHz, Rin_rx>1 kOhms) to reduce loss.

In the above-described transceiver FE 100, the noise factor (NF) of the LNA 110 in receiver branch 101 is reduced significantly as compared to the NF of an LNA in a standalone receiver (e.g., by approximately .2 dB @ 28 GHz). Furthermore, the impact on performance of the LNA 110 in receiver branch 101 as compared to performance of an LNA in a standalone receiver may be minimal. For example, LNA 110 of receiver branch 101 may exhibit only a small loss in gain (e.g., of approximately .4 dB @ 28 GHz) as compared to the gain seen in an LNA of a standalone receiver. Similarly, the impact on performance of PA 150 in transmitter branch 102 as compared to the performance of a PA in a standalone transmitter may also be minimal. For example, PA 150 in transmitter branch 102 may exhibit only a small loss in saturation power (Psat) (e.g., a Psat loss of approximately .15 dB @ 28 GHz), only a small loss in the one decibel (dB) compression point (P1dB) (e.g., a P1dB loss of approximately .25 dB), and only a small loss in power added efficiency (PAE) (e.g., a PAE loss of approximately 1.5% @ 28 GHz) as compared to Psat, P1dB, and PAE seen in the PA of a standalone transmitter.

The above-described transceiver FE 100 could be implemented in an advanced semiconductor-on-insulator processing technology platform. For example, transceiver FE 100 could be implemented in a partially depleted silicon-on-insulator (PDSOI) processing technology platform or a fully depleted silicon-on-insulator (FDSOI) processing technology platform. Alternatively, transceiver FE 100 could be implemented in any other processing technology platform suitable for RF frequency communication applications. Techniques for forming devices, such as transistors, inductors, resistors, capacitors, etc. in such processing technology platforms are well known in the art and, thus, the details thereof have been omitted from this specification in order to allow the reader to focus on the salient aspects of the disclosed embodiments including, but not limited to, integration of a variable inductor 120 and MCtl-controlled mode control switch 140 into a receiver branch 101 of a transceiver FE 100 and integration of a CCtl-controlled variable capacitor 170 into a transmitter branch 102.

It should be understood that the terminology used herein is for the purpose of describing the disclosed structures and methods and is not intended to be limiting. For example, as used herein, the singular forms “a,” “an,” and “the” are intended to include the plural forms as well, unless the context clearly indicates otherwise. Additionally, as used herein, the terms “comprises,” “comprising,” “includes,” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
an input/output pad; and
a receiver branch connected to the input/output pad and including:
a mode control switch;
a variable inductor including end nodes connected to the input/output pad and the mode control switch, respectively, wherein the variable inductor is connectable to ground through the mode control switch; and
a receiver branch amplifier connected to an intermediate node between a first portion and a second portion of the variable inductor.

2. The structure of claim 1, wherein, depending upon a state of the mode control switch, inductance of the variable inductor is at one of a first inductance value and a second inductance value that is greater than the first inductance value.

3. The structure of claim 2, further comprising a transmitter branch connected to the input/output pad, wherein, during a receiving mode, the first inductance value provides impedance matching for the receiver branch amplifier and wherein, during a transmitting mode, the second inductance value prevents leakage from the transmitter branch to the amplifier.

4. The structure of claim 2,
wherein the mode control switch is controllable by a mode control signal,
wherein, in a receiving mode, the mode control signal switches to a first voltage level causing the mode control switch to disconnect the variable inductor from ground so the variable inductor exhibits the first inductance value, and
wherein, in a transmitting mode, the mode control signal switches to a second voltage level that is different from the first voltage level causing the mode control switch to electrically connect the variable inductor to ground so the variable inductor exhibits the second inductance value.

5. The structure of claim 4, wherein the mode control switch includes an N-channel field effect transistor, wherein the mode control signal switches to one of zero volts and a negative voltage to turn off the N-channel field effect transistor during the receiving mode, and wherein the mode control signal switches to a positive voltage to turn on the N-channel field effect transistor during the transmitting mode.

6. The structure of claim 1, further comprising: a receiver branch capacitor having conductive plates connected to the input/output pad and an end node of the variable inductor, respectively.

7. The structure of claim 1, wherein the input/output pad is connected to a matching network and wherein the matching network is connected to an antenna.

8. The structure of claim 1, wherein the variable inductor is a spiral inductor.

9. A structure comprising:
an input/output pad; and
a transmitter branch connected to the input/output pad and including:
an output node connected to the input/output pad;
a transmitter branch amplifier;
a transformer connected between the transmitter branch amplifier and the output node; and
a variable capacitor connected to the output node.

10. The structure of claim 9, wherein the variable capacitor is programmable to cause capacitance of the variable capacitor to be at a first capacitance value, during a receiving mode, and to cause the capacitance of the variable capacitor to be at a second capacitance value that is greater than the first capacitance value, during a transmitting mode.

11. The structure of claim 9, wherein the variable capacitor is a digitally controlled capacitor.

12. The structure of claim 11,
wherein the digitally controlled capacitor includes multiple capacitors connected to the output node and further connectable by multiple capacitance control switches, respectively, to ground, and
wherein open and closed states of the multiple capacitance control switches are controlled by corresponding bits of a digital capacitance control signal to cause capacitance of the digitally controlled capacitor to be at a first capacitance value during a receiving mode and to be at a second capacitance value that is greater than the first capacitance value during a transmitting mode.

13. The structure of claim 12, wherein the multiple capacitance control switches each include at least one N-channel field effect transistor connected between a corresponding one of the multiple capacitors and ground.

14. The structure of claim 9, wherein the transmitter branch amplifier is a power amplifier.

15. The structure of claim 9, wherein the input/output pad is connected a matching network and wherein the matching network is connected to an antenna.

16. The structure of claim 9, further comprising a receiver branch connected to the input/output pad and including:
a mode control switch;
a variable inductor including end nodes connected to the input/output pad and the mode control switch, respectively, wherein the variable inductor is connectable to ground through the mode control switch; and
a receiver branch amplifier connected to an intermediate node between a first portion and a second portion of the variable inductor.

17. A structure comprising:
an input/output pad;
a receiver branch connected to the input/output pad and including:
a mode control switch;
a variable inductor including end nodes connected to the input/output pad and the mode control switch, respectively, wherein the variable inductor is connectable to ground through the mode control switch; and
a receiver branch amplifier connected to an intermediate node between a first portion and a second portion of the variable inductor; and
a transmitter branch connected to the input/output pad and including:
an output node connected to the input/output pad;
a transmitter branch amplifier;
a transformer connected between the transmitter branch amplifier and the output node; and
a variable capacitor connected to the output node.

18. The structure of claim 17,
wherein, during a receiving mode, inductance of the variable inductor is at a first inductance value and capacitance of the variable capacitor is at a first capacitance value, and
wherein, during a transmitting mode, the inductance of the variable inductor is at a second inductance value that is greater than the first inductance value and the capacitance of the capacitor is at a second capacitance value that is greater than the first capacitance value.

19. The structure of claim 18,
wherein the mode control switch is controllable by a mode control signal,
wherein, in the receiving mode, the mode control signal switches to a first voltage level causing the mode control switch to disconnect the variable inductor from ground so the inductance at the first inductance value, and
wherein, in the transmitting mode, the mode control signal switches to a second voltage level that is different from the first voltage level causing the mode control switch to electrically connect the variable inductor to ground so the inductance is at the second inductance value.

20. The structure of claim 18,
wherein the variable capacitor is a digitally controlled capacitor including multiple capacitors connected to the output node and further connectable by multiple switches, respectively, to ground, and
wherein open and closed states of the multiple switches are controlled by corresponding bits of a digital capacitance control signal to cause the capacitance to be at the first capacitance value, during the receiving mode, and to be at the second capacitance value, during the transmitting mode.
